(19) United States
(12) Patent Application Publication
(10) Pub. No.: US 2013/0087059 A1
(43) Pub. Date: Apr. 11, 2013

(54) SYSTEM AND METHOD FOR DETECTING DECORATOR WHEEL BLANKET DEFECTS

(71) Applicants: Brian M. Baird, Mantua, OH (US); Michael A. Kress, Uniontown, OH (US)

(72) Inventors: Brian M. Baird, Mantua, OH (US); Michael A. Kress, Uniontown, OH (US)

(73) Assignee: APPLIED VISION CORPORATION, Cuyahoga Falls, OH (US)

(21) Appl. No.: 13/267,162

(22) Filed: Oct. 6, 2011

(51) Int. Cl. B41F 23/04

(52) U.S. Cl. 101/416.1

(57) ABSTRACT

A system and method to detect defects in ink blankets of a decorator wheel. An image of each of a plurality of ink blankets of a decorator wheel is acquired using an optical inspection device of the system as the decorator wheel rotates past the optical inspection device during an inking process. Each acquired image is correlated to a unique ink blanket of the plurality of ink blankets. Each acquired image is further matched to a unique standard image of a correlated unique ink blanket. Each acquired image is also compared to a matching unique standard image to determine any defects.

### TECHNICAL FIELD

Certain embodiments of the present invention relate to systems and methods for detecting defects. More particularly, certain embodiments of the present invention relate to systems and methods detecting decorator wheel blanket defects.

### BACKGROUND

A rotating decorator wheel, having multiple ink blankets, is often used to transfer a decorative pattern of ink to (i.e., to decorate) a plurality of objects to be inked such as, for example, soda cans. As the decorator wheel rotates, each ink blanket picks up a pattern of ink. An adjacent rotating object wheel, having a plurality of objects to be decorated, is timed with the decorator wheel such that the ink pattern on each ink blanket is transferred to an outer surface of a separate corresponding object. The decorator wheel continues to rotate such that each ink blanket gets re-inked in order to subsequently decorate another object on the rotating object wheel during a next cycle. A defect occurring on an ink blanket (e.g., a rip or tear in an ink blanket) can result in objects being inked (i.e., decorated) incorrectly. As a result, it is desirable to detect a defect of an ink blanket as soon as possible, before too many objects are incorrectly decorated.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

An embodiment of the present invention comprises a method to detect a defect in an ink blanket of a decorator wheel. The method includes acquiring an image of each of a plurality of ink blankets of a decorator wheel using an optical inspection device as the decorator wheel rotates past the optical inspection device during an inking process. The method further includes correlating each acquired image to a unique ink blanket of the plurality of ink blankets using a processing device. The method also includes matching each acquired image to a unique standard image of a corresponding unique ink blanket based on the correlation using the processing device. The method further includes comparing each acquired image to a matching unique standard image using the processing device. In accordance with an embodiment, the comparing method step may include subtracting each acquired image from a matching unique standard image to form a subtraction image for each acquired image. The comparing method step may further include analyzing each subtraction image to identify the presence of a defect in a corresponding unique ink blanket. A defect may include at least one of a damaged (e.g., torn) blanket, an unwanted blob of ink on a blanket, a wanted ink color missing from the blanket, and a color shift in a wanted ink color on the blanket. In accordance with an embodiment, the correlating method step may include counting encoder pulses from an encoder on the decorator wheel as the decorator wheel rotates, and associating a count of the encoder pulses with a unique ink blanket identifier using the processing device. In accordance with an embodiment, the matching method step may include selecting a unique standard image having the unique ink blanket identifier using the processing device. Each image of each unique ink blanket may be acquired after inking of the blanket and before transferring of the ink from the blanket to an object to be inked (e.g., a soda can). Alternatively, each image of each unique ink blanket may be acquired after transferring of the ink from the blanket to an object to be inked and before re-inking of the blanket. The method may also include triggering an alarm in response to the comparing method step using the processing device. The method may further include generating a reject signal in response to the comparing method step, wherein the reject signal is correlated to a unique ink blanket having an identified defect. The method may also include generating a new unique standard image for each unique ink blanket in response to a user-initiated retraining command input to the processing device. The method step of acquiring an image by the optical inspection device may be initiated by a trigger signal from the processing device to the optical inspection device. The method may further include displaying a current image of a unique ink blanket, a unique standard image corresponding to the unique ink blanket, and a subtraction image corresponding to the unique ink blanket on a display device. The method may also include displaying an image on a display device in response to the comparing method step, wherein the displayed image corresponds to a unique ink blanket having an identified defect.

Another embodiment of the present invention comprises a system to detect a defect in an ink blanket of a decorator wheel. The system includes an optical inspection device configured to acquire an image of each of a plurality of ink blankets of a decorator wheel as the decorator wheel rotates past the optical inspection device during an inking process. The optical inspection device may include a visible spectrum color camera, in accordance with an embodiment. The system further includes a processing device operatively connected to the optical inspection device. The processing device may include a software programmable microprocessor and computer memory, in accordance with an embodiment. The processing device is configured to trigger the optical inspection device to acquire an image; correlate each acquired image to a unique ink blanket of the plurality of ink blankets; match each acquired image to a unique standard image of the corresponding unique ink blanket based on the correlation; and compare each acquired image to a matching unique standard image. The system may further include an encoder device attached to the decorator wheel and operatively connected to the processing device to provide encoder pulses to the processing device. As part of the correlation process, the processing device is configured to count the encoder pulses and associate a count of the encoder pulses with a unique ink blanket identifier. As part of the matching process, the processing device is also configured to select a unique standard ink blanket image having the unique ink blanket identifier. As part of the comparing process, the processing device is also configured to subtract each acquired image from a matching unique standard image to form a subtraction image for each acquired image. Also, as part of the comparing process, the processing device is configured to analyze each subtraction image to identify the presence of a defect in a corresponding unique ink blanket. A defect may include at least one of a damaged blanket (e.g., a torn blanket), an unwanted blob of ink on a blanket, a wanted ink color missing from the blanket, and a color shift in a wanted ink color on the blanket. The system may include an illuminator operatively connected to the processing device and configured to illuminate an ink blanket during image acquisition. Alternatively, the optical inspection device may include an illuminator to illuminate an ink blanket during image acquisition. The system may include a display device operatively connected to the processing device to display, for example, images. The system may also include a user interface device operatively connected to the processing device, allowing a user to interact with the system.

A further embodiment of the present invention comprises a method for calibrating a system for detecting a defect in an ink blanket of a decorator wheel. The method includes inputting a first setup number into a processing device of the system corresponding to a number of unique ink blankets on a decorator wheel. The method further includes inputting a second setup number into the processing device of the system corresponding to a number of expected encoder pulses between adjacent unique ink blankets. The method also includes receiving an index encoder pulse from an encoder of the decorator wheel into the processing device as the decorator wheel rotates. The method further includes identifying a first unique ink blanket that first passes by an optical inspection device adjacent to the decorator wheel after receiving the index encoder pulse, and recording an associated first blanket identifier in a memory of the processing device. The method also includes adjusting a first blanket image acquisition delay of the system to center the first unique ink blanket with respect to the optical inspection device during image acquisition, and recording the adjusted first blanket image acquisition delay in a memory of the processing device. The method may further include identifying subsequent unique ink blankets on the decorator wheel with respect to the first blanket identifier of the first unique ink blanket and recording subsequent associated blanket identifiers in a memory of the processing device. The method may further include acquiring a unique standard image for each unique ink blanket of the decorator wheel as the decorator wheel rotates using the optical inspection device. The method may also include storing each acquired unique standard image in a memory of the processing device, indexed by an associated blanket identifier.

These and other advantages and novel features of the present invention, as well as details of illustrated embodiments thereof, will be more fully understood from the following description and drawings.

### BRIEF DESCRIPTION OF THE DRAWINGS

FIG. 1 illustrates an example embodiment of a system for identifying defects in blankets of a decorator blanket wheel;

FIG. 2 is a flowchart of an example embodiment of a method to detect a defect in an ink blanket of a decorator wheel using the system of FIG. 1;

FIG. 3 is a flowchart of an example embodiment of a method for calibrating the system of FIG. 1 for detecting a defect in an ink blanket of a decorator wheel; and

FIG. 4 illustrates an example embodiment of three related blanket images.

### DETAILED DESCRIPTION

Embodiments of the systems and methods described herein provide for identifying defects in particular ink blankets of a decorator wheel. A decorator wheel may be implemented in an aluminum can facility, for example, for the purpose of decorating (i.e., inking) the exterior surfaces of the aluminum cans in a serial manner as the aluminum cans travel along a processing line. In accordance with an embodiment of a method herein, a separate image of each particular unique ink blanket of a decorator wheel is acquired and correlated to that particular unique ink blanket such that any acquired image can be matched and compared to a standard image of the same exact ink blanket. In this manner, a defect can be isolated to a particular ink blanket.

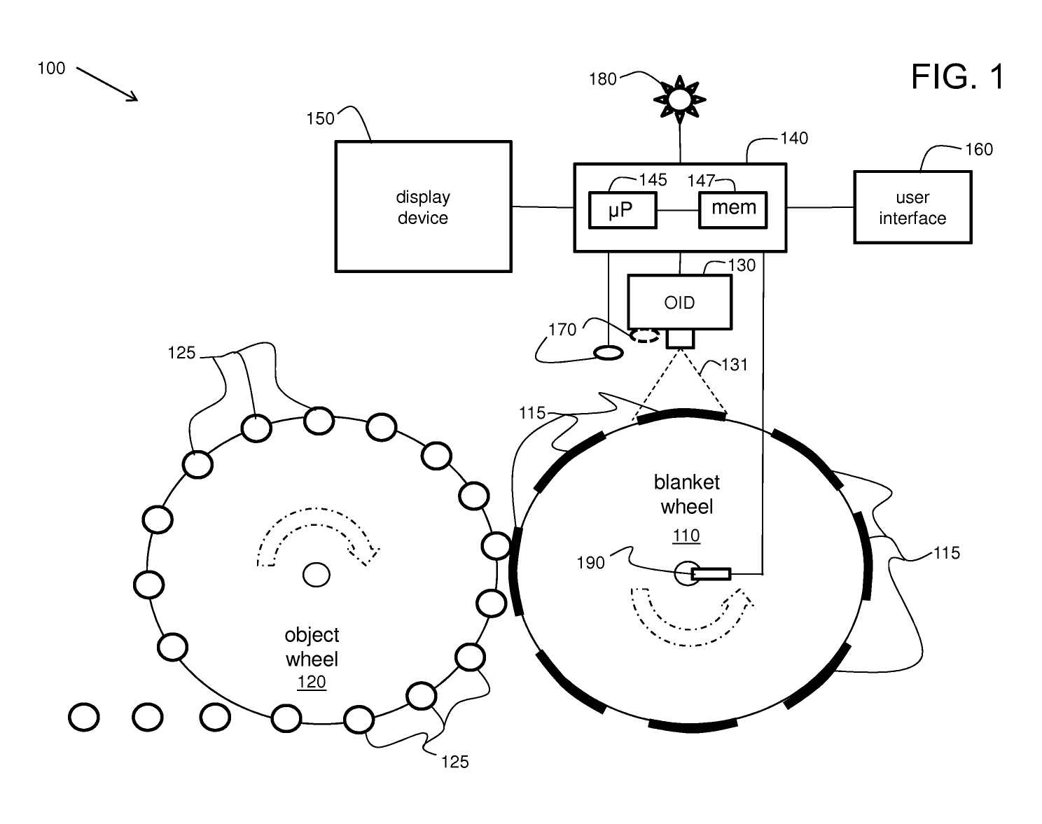

FIG. 1 illustrates an example embodiment of a system 100 for identifying defects in blankets of a decorator blanket wheel. The system 100 includes a decorator wheel 110 having a plurality of ink blankets 115. In accordance with an embodiment, the decorator wheel may have a diameter of about four feet, for example. The system 100 also includes an object wheel 120 carrying a plurality of objects 125 to be decorated such as, for example, soda cans or beer cans. The object wheel 120 is positioned adjacent to the decorator wheel 110 as shown in FIG. 1. The object wheel 120 and the decorator wheel 110 are configured to rotate in opposite directions as indicated by the dotted arrow on each wheel in FIG. 1. In the embodiment of FIG. 1, eight ink blankets 115 are positioned around the perimeter of the decorator wheel 110. The ink blankets 115 may be rubberized (e.g., made of or covered with a rubber material, a rubber-like material, or some other material that is adequate for facilitating the inking process, in accordance with various embodiments).

As the decorator wheel 110 rotates, each ink blanket 115 picks ups a pattern of wet ink from an ink source or inker (not shown). The decorator wheel 110 is synchronized with the object wheel 120 such that, as both wheels rotate, each ink blanket 115 on the decorator wheel 110 meets up with an object 125 on the object wheel 120 and the ink pattern is transferred from the ink blanket 115 to the object 125. New, un-decorated objects are constantly fed onto the object wheel 120 and inked objects are constantly removed from the object wheel 120 as the object wheel rotates. Once ink is transferred from an ink blanket 115, the ink blanket 115 subsequently approaches the ink source again as the decorator wheel rotates, picking up a fresh pattern of wet ink to be applied to another object 125 on the object wheel 120. In accordance with an embodiment, about 2000 objects per minute can be inked in real time with a single object wheel/decorator wheel pair.

The system 100 also includes an optical inspection device (OID) 130. The OID 130 is positioned adjacent to the decorator wheel 110 such that the OID 130 can acquire an image of each ink blanket 115 as each ink blanket 115 passes within the field-of-view 131 of the OID 130 as the decorator wheel 110 rotates. The OID 130 may be positioned at different places with respect to the decorator wheel 110, in accordance with various embodiments. For example, the OID 130 may be positioned so as to acquire an image of an ink blanket 115 after inking of the ink blanket 115 but before the ink is transferred to an object 125. Alternatively, the OID 130 may be positioned so as to acquire an image of an ink blanket 115 after transferring of the ink to an object 125 but before re-inking of the blanket 115. In accordance with an embodiment, the OID 130 is a visible spectrum color camera (e.g., a digital color camera) that can be triggered at a rate of about 30 Hz to acquire images.

The system 100 further includes a processing device 140 having a software programmable microprocessor 145 and computer memory 147. The processing device 140 is operatively connected to the OID 130 to receive digital image data from the OID 130 and to send a signal to the OID 130 to trigger the OID 130 to acquire an image. The processing device 140 is configured to perform various other functions as well, as described later herein.

The system 100 includes a display device 150 operatively connected to the processing device 140. The display device 150 is configured to display images acquired by the OID 130 and processed by the processing device 140. The system 100 also includes a user interface 160 operatively connected to the processing device 140 and providing the ability for a user to communicate with the processing device 140 (e.g., input set up information). In accordance with an alternative embodiment of the present invention, the user interface may be effectively integrated with the display device and the processing device. For example, the user interface may be implemented in software that is executing on the processing device, but displayed on the display device.

The system 100 further includes an illuminator 170 operatively connected to the processing device 140 and configured to illuminate an ink blanket during image acquisition. The illuminator 170 may be a strobe light that is triggered by a signal from the processing device 140 when an image is to be acquired (e.g., at about a 30 Hz rate), in accordance with an embodiment. Other types of illuminators are possible as well, in accordance with various other embodiments. As an alternative, the illuminator 170 may be an integral part of the OID 130, or may operatively interface to the OID 130.

The system 100 includes an alarm device 180 operatively connected to the processing device 140. The alarm device 180 may be any of various types of alarm devices including, but not limited to, a flashing light, an acoustic siren, or a vibrating device configured to be worn by a user. Furthermore, the alarm device 180 may be wired or wireless with respect to the processing device 140. If wireless, the alarm device 180 may be a portable device.

The system 100 also includes a high resolution encoder device 190 operatively connected to the decorator wheel 110 (e.g., operatively connected to a central shaft of the decorator wheel). The encoder device 190 senses the rotation of the decorator wheel 110 and outputs encoder pulses to the processing device 140. In accordance with an embodiment, the encoder device 190 outputs a single index encoder pulse every rotation of the decorator wheel 110, and outputs a plurality of non-index encoder pulses (i.e., encoder pulses), between index encoder pulses, at regular intervals corresponding to the rotational angle of the decorator wheel 110. Such encoder devices are well known in the art.

The processing device 140 counts the encoder pulses with respect to the index encoder pulse, thereby determining the rotational position of the decorator wheel 110 at any given time. As a result, the system 100 can be calibrated, based on the pulses from the encoder device, to determine when any particular ink blanket is within the field-of-view 131 of the OID 130. The processing device 140 can then trigger the OID 130 (and illuminator 170) to acquire an image of a blanket within the field-of-view 131.

Referring to FIG. 1, as the decorator wheel 110 and the object wheel 120 rotate with respect to each other during a decorating run, the OID 130 acquires an image of each ink blanket 115 as it passes within the field-of-view 131. Each image (in the form of digital image data) is communicated from the OID 130 to the processing device 140. The processing device 140 performs the functional processing to determine if any image (and, therefore, any associated ink blanket) appears to have a defect. The system 100 is able to determine which image is associated with which exact ink blanket 115 and, therefore, is able to isolate any detected defect to a particular ink blanket 115 through a process of correlation and matching, as described later herein. In accordance with an embodiment, a defect may include one or more of a damaged blanket (e.g., a torn or ripped blanket), an unwanted blob of ink on a blanket, a wanted ink color missing from the blanket, and a color shift in a wanted ink color on the blanket.

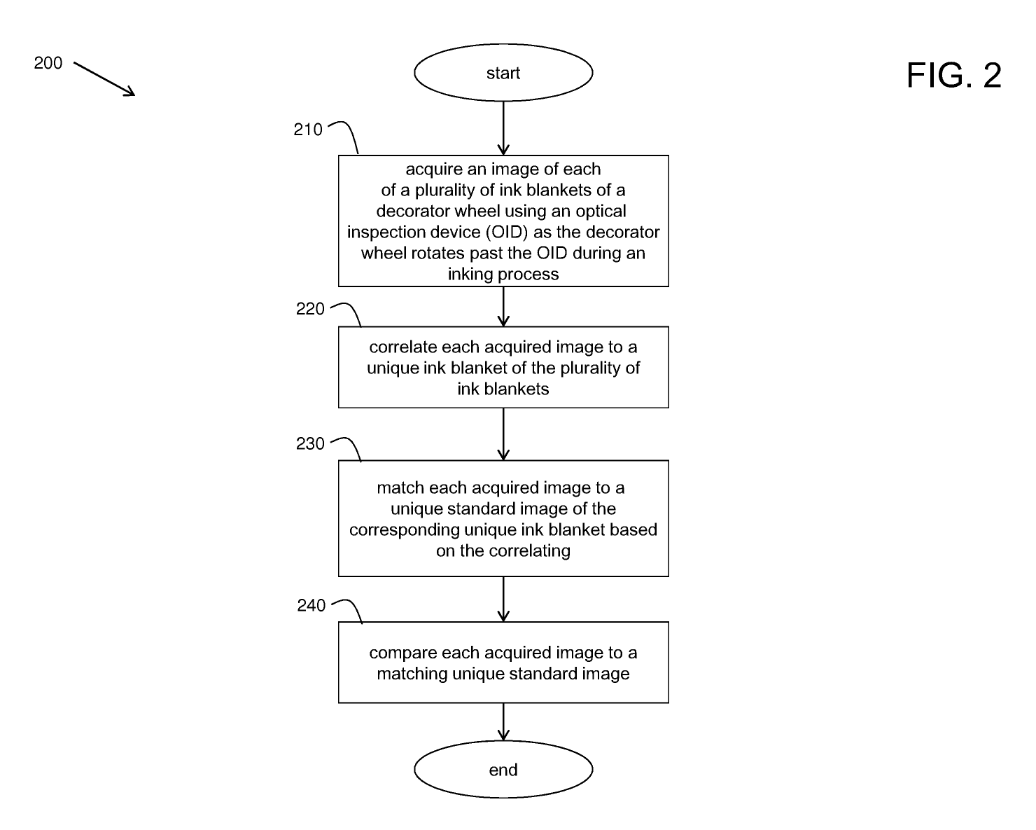

FIG. 2 is a flowchart of an example embodiment of a method 200 to detect a defect in an ink blanket 115 of a decorator wheel 110 using the system 100 of FIG. 1. In step 210, an image of each of a plurality of ink blankets 115 of a decorator wheel 110 is acquired using an optical inspection device (OID) 130 as the decorator wheel 110 rotates past the OID 130 during an inking process. In accordance with one embodiment, each image of each unique ink blanket is acquired after inking of the blanket and before transferring of the ink from the blanket to the object (e.g., can) to be inked (i.e., the blanket is imaged while the blanket is still wet with ink). In accordance with an alternative embodiment, each image of each unique ink blanket is acquired after transferring of the ink from the blanket to an object to be inked and before re-inking of the blanket (i.e., the blanket is imaged while the blanket is relatively dry or free of ink). It is known in the art that, even though ink has been transferred from a blanket to an object, the blanket may still retain some residual ink being indicative of the ink pattern being applied.

In step 220, each acquired image is correlated to a unique ink blanket 115 of the plurality of ink blankets using a processing device 140. In step 230, each acquired image is matched to a unique standard image of the corresponding unique ink blanket 115 based on the correlating method step using a processing device 140. In step 240, each acquired image is compared to a matching unique standard image using a processing device 140. Since the comparison of any two images is always being done with respect to the same exact ink blanket, any oscillation or motion in the blanket, which repeats, is automatically accounted for in the system. For example, blanket x and blanket x+1 may show up in an image frame as slightly different positions due to various mechanical inaccuracies. However, blanket x will always appear in the exact same spatial position in the image frame, and blanket x+1 will also. Therefore, there is no reason to align an acquired image with a standard image before performing the comparison step. The acquired and standard images, for a particular unique ink blanket, will always be in the same spatial position with respect to each other. Furthermore, ink blankets get reused (e.g., to apply different ink patterns to the same blanket). Sometimes, a portion of a previous ink pattern can still be seen on an ink blanket that is currently being inked with a new ink pattern. Therefore, it is important to compare images of the exact same ink blanket each time a comparison is performed.

When the OID 130 acquires an image of an ink blanket 115, the image is sent to the processing device 140. In order to correlate each acquired image to a unique ink blanket, the processing device 140 counts encoder pulses from the encoder device 190 on the decorator wheel 110 as the decorator wheel 110 rotates, and associates a count of the encoder pulses with a unique ink blanket identifier. The system 100 has been previously calibrated, as described later herein, in order for the processing device 140 to properly perform the correlation.

In order to match each acquired image to a unique standard image of a corresponding unique ink blanket 115, the processing device 140 selects a unique standard image from a plurality of unique standard images stored on the processing device (e.g., in memory 147). Each unique standard image stored on the processing device 140 represents a unique ink blanket 115 on the decorator wheel 110 that is free of any defects (i.e., represents a “good” ink blanket). The processing device 140 is able to select the correct unique standard image based on the unique ink blanket identifier from the correlation process. That is, each unique standard image is assigned a unique ink blanket identifier (e.g., in the form of a number), and the correlation process (by counting the encoder pulses) ensures that the correct unique ink blanket identifier is associated with the currently imaged ink blanket 115. As a result, each ink blanket that is imaged by the OID 130 during a decorating run is matched to a standard image of that exact same ink blanket without having to search for and analyze the plurality of unique standard images to find the correct matching unique standard image.

The processing device 140 then compares the currently acquired image of an ink blanket 115 to the matching standard image by, for example, subtracting the acquired image from the standard image to form a subtraction image, in accordance with an embodiment. The subtraction image may then be analyzed by the processing device 140 to determine if there are any defects in the currently acquired image of that particular unique ink blanket 115. In accordance with an embodiment, the images are color images in the form of red (R), green (G), blue (B) image pixel data. One skilled in the art can appreciate that, when the images are subtracted, the resultant subtraction image can be a grayscale image, where R, G, and B are of the same numerical value for each pixel in the image.

The analysis of the subtraction image may be as simple as determining a change between the acquired image and the matching standard image. For example, a cumulative number of pixels in the subtraction image that are non-zero valued (or a cumulative number of pixels in the subtraction image that are outside of some range around zero value) can be determined and the cumulative value can be compared to a threshold value where, for example, a cumulative number being above the threshold value is indicative of a defect. Alternatively, the analysis may be more complex, including performing detailed image processing on various regions of interest within the subtraction image to isolate a defect to a location on the blanket and/or to, for example, to identify or categorize the type of defect (e.g., a torn blanket, an ink blob, a missing color, etc.).

If a defect of a unique ink blanket 115 is detected by the system 100, the processing device 140 can trigger an alarm by sending an alarm signal to the alarm device 180 to alert a user of the system 100. The user can react, for example, by shutting down the system 100 before a large number of cans become mis-inked by the defective blanket. Furthermore, the processing device 140 can send an image of the defective ink blanket (with a blanket identifier) to the display device 150, allowing the user to view the defect and to know which blanket 115 on the decorator wheel 110 has the defect. In accordance with an embodiment, a reject signal can be generated by the processing device 140 which can be output and used by another system of the facility (e.g., by the aluminum can facility) to eject an object off of the processing line downstream of the object wheel 120. The reject signal may be correlated to an object on the processing line to eject the corresponding defective object. For example, a defective soda can, coming off of the object wheel onto a pin chain and heading toward an oven, can be blown off the pin chain when a blower of the facility is triggered by the reject signal (or some derivative signal thereof).

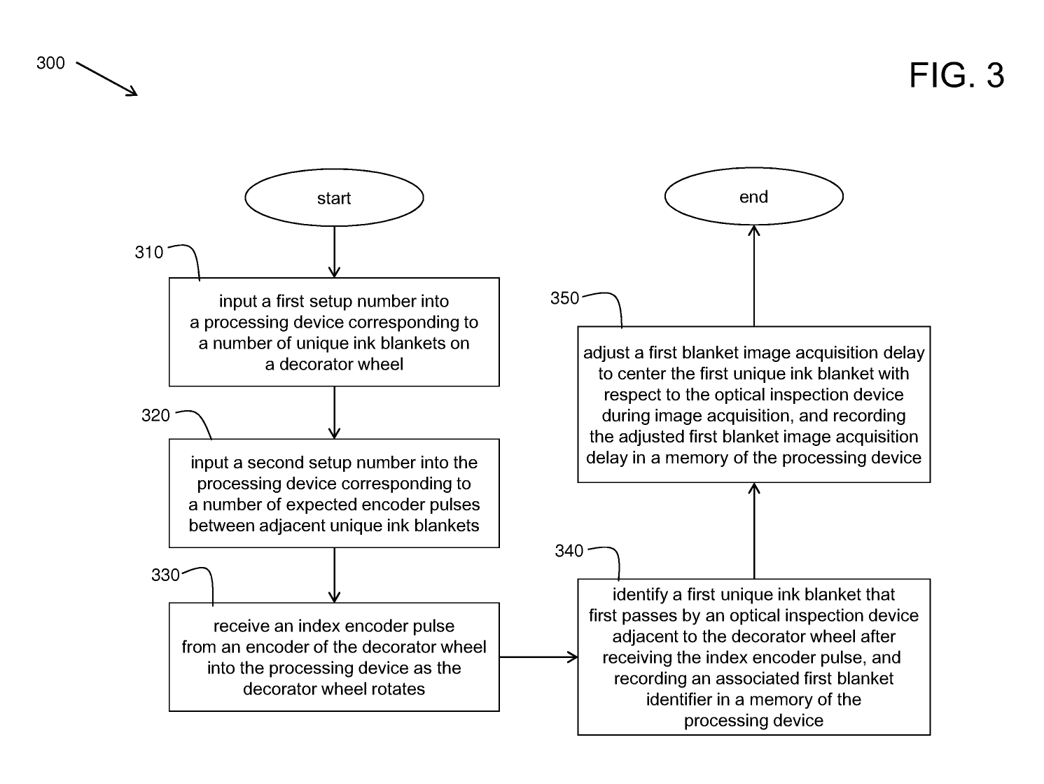

FIG. 3 is a flowchart of an example embodiment of a method 300 for calibrating the system 100 of FIG. 1 for detecting a defect in an ink blanket 115 of a decorator wheel 110. In step 310, a first setup number is input into the processing device 140 of the system 100 corresponding to a number of unique ink blankets 115 on the decorator wheel 110. For example, a user may input the number “8”, via the user interface 160, to indicate to the processing device 140 that the decorator wheel 110 has eight unique ink blankets. In step 320, a second setup number is input into the processing device 140 of the system 100 corresponding to a number of expected encoder pulses between adjacent unique ink blankets 115. For example, a user may input the number “128”, via the user interface 160, to indicate to the processing device 140 that there should be about “128” encoder pulses that get received by the processing device 140 from the time one unique ink blanket 115 is within the field-of-view 131 of the OID 130 to the time a next unique ink blanket 115 is within the field-of-view 131 as the decorator wheel 110 rotates. In accordance with an embodiment, a set up screen is displayed on the display device 150 to facilitate the calibration process. The user can view the set up screen and interact with the set up screen via the user interface 160, for example.

In step 330, an index encoder pulse is received by the processing device 140 from the encoder device 190 as the decorator wheel 110 is rotated. In step 340, a first unique ink blanket that first passes by the optical inspection device 130 adjacent the decorator wheel 110 is identified after receiving the index encoder pulse. Encoder pulses, received by the processing device 140 between the received index encoder pulse and when the first unique ink blanket first passes by the OID 130, are counted by the processing device 140. An associated first blanket identifier (e.g., #4) is recorded in a memory 147 of the processing device 140. As a result, the system 100 has established a reference point. That is, the processing device 140 now “knows” which unique ink blanket (e.g., blanket number “4”) comes into the field-of-view 131 first after receiving the index encoder pulse, which occurs once per revolution of the decorator wheel 110.

In step 350, a first blanket image acquisition delay of the system 100 is adjusted to center the first unique ink blanket (e.g., ink blanket #4) with respect to the OID 130 during image acquisition. The adjustment may be performed by a user via the user interface 160 while viewing acquired images of the first unique ink blanket (e.g., ink blanket #4) on the display device 150. The adjusted first blanket image acquisition delay is also recorded in a memory 147 of the processing device 140 to be subsequently used during a decorating run to determine exactly when, with respect to the index encoder pulse, the first ink blanket (e.g., ink blanket #4) is centered within the field-of-view 131 of the OID 130.

Similarly, the method also includes identifying subsequent unique ink blankets 115 (e.g., ink blankets #5, #6, #7, #8, #1, #2, #3) on the decorator wheel 110 with respect to the first blanket identifier of the first unique ink blanket (e.g., ink blanket #4) and recording subsequent associated blanket identifiers in a memory 147 of the processing device 140. As an option, the method may further include adjusting subsequent blanket image acquisition delays of the system to center subsequent unique ink blankets with respect to the optical inspection device during image acquisition, and recording the adjusted subsequent blanket image acquisition delays in a memory 147 of the processing device. However, in general, since the number of unique blankets and the number of expected encoder pulses between blankets have been entered, and since a first image blanket delay has been entered, the subsequent ink blankets should be centered. Therefore, additional image acquisition delays should not be needed.

As a result, by knowing when an index encoder pulse is received, knowing the expected number of encoder pulses between ink blankets, knowing the identifier for each ink blanket with respect to the occurrence of the index encoder pulse, and applying the blanket image acquisition delay for at least the first identified ink blanket, the processing device 140 is calibrated to trigger the OID 130 to acquire an image of an identified ink blanket whenever an ink blanket is centered within the field-of-view 131 as the decorator wheel 110 rotates.

Once the system 100 is calibrated according to the method 300, a user may run the system 100 to acquire a unique standard (i.e., defect-free) image for each unique ink blanket 115. The set of unique standard images, along with their corresponding ink blanket identifiers, are stored in the memory 147 of the processing device. Such acquiring and storing of the standard images is referred to as training of the system. After the system 100 is calibrated and a set of unique standard images is acquired and stored, the system 100 can be used during a decorator processing run to decorate objects while looking for defects as described previously herein. An embodiment of the present invention provides a single action retraining capability. For example, the user interface 160 can include a single button which the user can press to cause the system to acquire and store a new set of unique standard images. Such retraining may be desirable after the ink label of the blankets is changed or when some other operating condition has changed.

As an example, during set up, a user may input two number into the system that indicate that there are 12 ink blankets and about 200 encoder pulses expected to occur between adjacent ink blankets on the decorator wheel. Then it is determined that ink blanket #7 is the first ink blanket that passes by the OID after the index encoder pulse is received. The number of encoder pulses received between the time of occurrence of the index encoder pulse and when ink blanket #7 is within the field-of-view of the OID are counted as being 75 encoder pulses. Then, as the decorator wheel is rotating and the OID is being triggered to acquire images of blanket #7, the user adjusts the first blanket image acquisition delay by 4 fewer encoder pulses to center the acquired images in the field-of-view. This puts the number of encoder pulses after the index encoder pulse as being 71 (i.e., 75-4) encoder pulses, which centers blanket #7 in the field-of-view. As a result, during operation, the OID is triggered to acquire an image of ink blanket #7 after the processing device counts 71 encoder pulses after receiving the index encoder pulse.

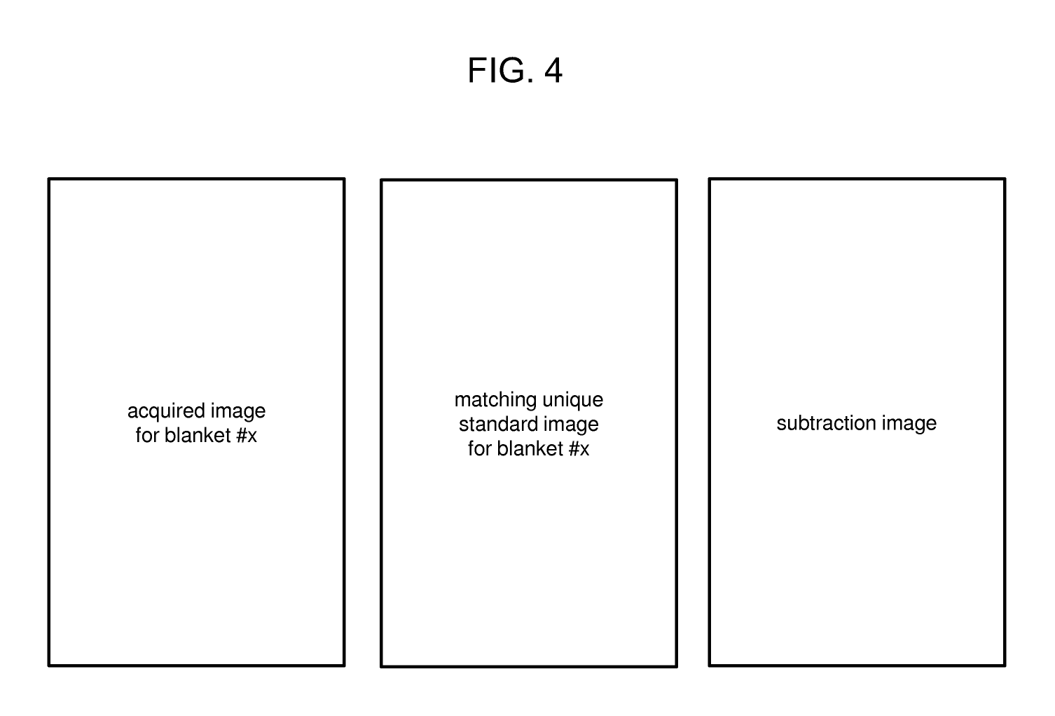

FIG. 4 illustrates an example embodiment of three related blanket images. During operation, a user may choose to display three related images corresponding to a particular, unique ink blanket on the decorator wheel. A matching unique standard image for blanket #x, an acquired image for blanket #x, and the corresponding subtraction image are displayed, in order, as shown in FIG. 4. Blanket #x may correspond to a blanket that has been determined by the system 100 to have a defect. The user can view the three images, side-by-side, to obtain a better indication of the nature of the failure (e.g., a tear in the blanket, an ink blob on the blanket, etc.).

When a defect is detected and associated with a particular ink blanket in accordance with the systems and methods described herein, a user can stop the decorator run and the exact defective ink blanket on the wheel can be serviced (e.g., replaced) without having to manually examine all the ink blankets to determine which one is defective.

Furthermore, in accordance with an embodiment, the processing device 140 provides an ignore signal. For example, the user may press an ignore button on the user interface 160 which signals the processing device 140 to ignore any future defects that may be detected and not activate an alarm. Such an ignore signal may be desirable to use at times when the system is being set up or tested for some other condition, for example, when an ink label is being changed.

In summary, a system and method to detect defects in ink blankets of a decorator wheel are disclosed. An image of each of a plurality of ink blankets of a decorator wheel is acquired using an optical inspection device of the system as the decorator wheel rotates past the optical inspection device during an inking process. Each acquired image is correlated to a unique ink blanket of the plurality of ink blankets. Each acquired image is further matched to a unique standard image of a correlated unique ink blanket. Each acquired image is also compared to a matching unique standard image to determine any defects.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A method to detect a defect in an ink blanket of a decorator wheel, said method comprising:
acquiring an image of each of a plurality of ink blankets of a decorator wheel using an optical inspection device as the decorator wheel rotates past the optical inspection device during an inking process;
correlating each acquired image to a unique ink blanket of said plurality of ink blankets using a processing device;
matching each acquired image to a unique standard image of a corresponding unique ink blanket based on the correlating using said processing device; and
comparing each acquired image to a matching unique standard image using said processing device.

2. The method of claim 1, wherein said comparing includes subtracting each acquired image from a matching unique standard image to form a subtraction image for each acquired image.

3. The method of claim 2, wherein said comparing further includes analyzing each subtraction image to identify the presence of a defect in a corresponding unique ink blanket.

4. The method of claim 3, wherein said defect includes at least one of a damaged blanket, an unwanted blob of ink on a blanket, a wanted ink color missing from the blanket, and a color shift in a wanted ink color on the blanket.

5. The method of claim 1, wherein said correlating includes counting encoder pulses from an encoder on the decorator wheel as the decorator wheel rotates, and associating a count of said encoder pulses with a unique ink blanket identifier using said processing device.

6. The method of claim 5, wherein said matching includes selecting a unique standard image having said unique ink blanket identifier using said processing device.

7. The method of claim 1, wherein each image of each unique ink blanket is acquired after inking of the blanket and before transferring of the ink from the blanket to an object to be inked.

8. The method of claim 1, wherein each image of each unique ink blanket is acquired after transferring of the ink from the blanket to an object to be inked and before re-inking of the blanket.

9. The method of claim 1, further comprising triggering an alarm in response to said comparing using said processing device.

10. The method of claim 1, further comprising generating a reject signal in response to said comparing, wherein said reject signal is correlated to a unique ink blanket having an identified defect.

11. The method of claim 1, further comprising generating a new unique standard image for each unique ink blanket in response to a user-initiated retraining command input to said processing device.

12. The method of claim 1, wherein said acquiring an image by said optical inspection device is initiated by a trigger signal from said processing device to said optical inspection device.

13. The method of claim 1, further comprising displaying a current image of a unique ink blanket, a unique standard image corresponding to said unique ink blanket, and a subtraction image corresponding to said unique ink blanket on a display device.

14. The method of claim 1, further comprising displaying an image on a display device in response to said comparing, wherein said displayed image corresponds to a unique ink blanket having an identified defect.

15. A system to detect a defect in an ink blanket of a decorator wheel, said system comprising:
an optical inspection device configured to acquire an image of each of a plurality of ink blankets of a decorator wheel as the decorator wheel rotates past the optical inspection device during an inking process; and
a processing device operatively connected to said optical inspection device and configured for:
triggering said optical inspection device to acquire an image;
correlating each acquired image to a unique ink blanket of said plurality of ink blankets,
matching each acquired image to a unique standard image of the corresponding unique ink blanket based on the correlating, and
comparing each acquired image to a matching unique standard image.

16. The system of claim 15, further comprising an encoder device attached to the decorator wheel and operatively connected to the processing device to provide encoder pulses to the processing device.

17. The system of claim 16, wherein said processing device is configured to count said encoder pulses and associate a count of said encoder pulses with a unique ink blanket identifier as part of said correlating.

18. The system of claim 17, wherein said processing device is configured to select a unique standard ink blanket image having said unique ink blanket identifier as part of said matching.

19. The system of claim 15, wherein said processing device is configured to subtract each acquired image from a matching unique standard image to form a subtraction image for each acquired image as part of said comparing.

20. The system of claim 19, wherein said processing device is configured to analyze each subtraction image to identify the presence of a defect in a corresponding unique ink blanket as part of said comparing.

21. The system of claim 20, wherein said defect includes at least one of a damaged blanket, an unwanted blob of ink on a blanket, a wanted ink color missing from the blanket, and a color shift in a wanted ink color on the blanket.

22. The system of claim 15, wherein said optical inspection device includes a visible spectrum color camera.

23. The system of claim 15, wherein said processing device includes a software programmable microprocessor and computer memory.

24. The system of claim 15, further comprising an illuminator operatively connected to said processing device and configured to illuminate an ink blanket during image acquisition.

25. The system of claim 15, wherein said optical inspection device includes an illuminator to illuminate an ink blanket during image acquisition.

26. The system of claim 15, further comprising a display device operatively connected to said processing device.

27. The system of claim 15, further comprising a user interface device operatively connected to said processing device.

28. A method for calibrating a system for detecting a defect in an ink blanket of a decorator wheel, said method comprising:
inputting a first setup number into a processing device of the system corresponding to a number of unique ink blankets on a decorator wheel;
inputting a second setup number into the processing device of the system corresponding to a number of expected encoder pulses between adjacent unique ink blankets;
receiving an index encoder pulse from an encoder of the decorator wheel into the processing device as the decorator wheel rotates;
identifying a first unique ink blanket that first passes by an optical inspection device adjacent to the decorator wheel after receiving the index encoder pulse, and recording an associated first blanket identifier in a memory of the processing device; and
adjusting a first blanket image acquisition delay of the system to center the first unique ink blanket with respect to the optical inspection device during image acquisition, and recording said adjusted first blanket image acquisition delay in a memory of the processing device.

29. The method of claim 28, further comprising identifying subsequent unique ink blankets on the decorator wheel with respect to the first blanket identifier of the first unique ink blanket.

30. The method of claim 29, further comprising acquiring a unique standard image for each unique ink blanket of said decorator wheel as said decorator wheel rotates using said optical inspection device.

31. The method of claim 30, further comprising storing each acquired unique standard image in a memory of said processing device, indexed by an associated blanket identifier.
